(19) United States
(12) Patent Application Publication
(10) Pub. No.: US 2008/0091861 A1
(43) Pub. Date: Apr. 17, 2008

(54) Bus Multiplexer Apparatus and Method

(76) Inventor: Richard Earl Jones, Plainfield, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/666,481

(22) PCT Filed: Oct. 25, 2005
(86) PCT No.: PCT/US05/38755

§ 371 Date: Apr. 27, 2007

Related U.S. Application Data
(60) Provisional application No. 60/622,975, filed on Oct. 28, 2004.

(51) Int. Cl. G06F 13/42

(52) U.S. Cl. 710/106

(57) ABSTRACT

An apparatus including a first peripheral device coupled to a digital bus; a second peripheral device coupled to the digital bus; a controller coupled to the first and second peripheral devices via the digital bus, the digital bus including first and second switches disposed between the controller and the first and second peripheral devices, respectively, the controller controlling the state of the first and second switches, the controller transmitting to and receiving data from the first and second peripheral devices via the digital bus and the first and second switches, the controller isolating a selected one of the first and second peripheral devices by controlling the state of an associated one of the first and second switches when data is not being transmitted to or received from the selected one of the first and second peripheral devices

### FIELD OF THE INVENTION

This invention generally relates to a digital bus multiplexer for controlling separate devices connected to a host controller, whereby devices can be selectively connected and/or isolated from the digital bus.

### BACKGROUND OF THE INVENTION

Configurations and methodologies for interconnecting a controller with one or more peripheral devices, via a common digital bus are generally known. “Controller”, as used herein, generally refers to a device that controls the transfer of data between a computing device and a peripheral device. A controller is sometimes called a “host”. “Computing device”, as used herein, generally refers to a programmable machine that responds to a specific set of instructions in a predictable manner and executes a prerecorded list of such instructions (e.g., a program or software). A computing device generally includes a processor, which generally include a Central Processing Unit (CPU). A CPU generally includes an arithmetic logic unit (ALU) that performs arithmetic and logical operations, and a control unit that extracts instructions (e.g., a program) from memory and decodes and executes them, calling on the ALU when necessary. Non-limiting examples of computing devices include personal computers and set-top boxes. Non-limiting examples of set-stop boxes include satellite and cable television receivers, and personal video recorders (PVRs). Set-top boxes typically further include conventional decoders for decoding data indicative of multimedia content. “Peripheral device” (or “device”), as used herein-below, generally refers to a machine or component that attaches to a computing device. Non-limiting examples of devices include disk drives (e.g., optical disc drives such as compact disc drives, DVD drives, and hard-drives), display screens, keyboards and printers. “Bus”, as used herein, generally refers to a digital bus or collection of electrical conductors through which signals indicative of data are transmitted.

Referring now to FIG. 1, there is shown a configuration 10 including a controller 20 communicatively coupled to a device 40 via a bus 30. For non-limiting purposes of explanation, the present invention will be discussed as it relates to an ATA/ATAPI compliant bus. This specification is well known, and described in the CITS 317-1998 AT Attachment-4 with Packet Interface Extension document commercially available from ANSI, for example. As will be understood by those possessing an ordinary skill in the pertinent arts though, the present invention has applicability to a wide-range of other types of digital buses, and should not be considered as being limited to ATA/ATAPI compliant buses.

Referring now also to FIG. 2, there is shown a process flow 50 for operating an ATA/ATAPI configuration of FIG. 1. In such a case, the host (e.g., controller 20) may issue programmed input/output (PIO) commands to device 40. The ATA/ATAPI bus PIO command protocol can be summarized as follows. First, the host employs a process 51 that selects a device. The host then employs a process 52 that writes a command and parameters to the selected device. The host then employs a process 53 that transfers data to the selected device (e.g., write type commands). Thereafter, the selected device employs a process 54 that executes the command. A further process 55 transfers data from the selected device (read type commands). Finally, the host employs a process 56 that de-selects the selected device. The bus is reserved for the selected device in process 51, and remains reserved through process 56.

Referring now to FIG. 3, there is shown a configuration 10′ including a controller 20 communicatively coupled to devices 40, 40′ via bus 30. In the case of an ATA/ATAPI compliant configuration, a host (e.g., controller 20) may issue programmed input/output (PIO) commands to two separate devices 40, 40′ sharing an ATA/ATAPI bus 30. In such a configuration, devices 40, 40′ may take the form of an optical disc drive (ODD) and a hard disk drive (HDD), respectively. To allow a single host 20 and one or two devices 40, 40′ to be connected to the same bus 30, the ATA/ATAPI specification calls for implementation of a non-overlap mode. In the non-overlap mode, the ATA/ATAPI specification only allows the host 20 to issue a command to a single device 40, 40′ at a given time. This effectively prevents the two devices 40, 40′ from operating in parallel. Further, this feature set must be implemented in both devices 40, 40′ that share the common ATA/ATAPI bus. Moreover, due to its complexity, few optical disc drive devices currently implement this feature set.

In some applications this may not be considered a significant drawback. However, in applications where data such as multimedia content is to be streamed to and/or from the devices 40, 40′, this drawback can limit data throughput and cause data being written to one device 40, 40′ to be lost, in the event problems arise with respect to the other device 40, 40′. This drawback may be exacerbated where different multimedia content is to be streamed simultaneously. For example, a scratch on a DVD disc being read by an optical drive may lead to a delayed reading from a hard disk drive connected to a common bus, as the bus is tied up by the optical drive longer than may have been anticipated.

A device and method that addresses the shortcomings of the prior art, and enables multiple devices coupled to a common host to operate in parallel, is desirable

### SUMMARY OF THE INVENTION

According to an aspect of the present invention, as apparatus includes a first peripheral device coupled to a digital bus; a second peripheral device coupled to the digital bus; a controller coupled to the first and second peripheral devices via the digital bus, the digital bus including first and second switches disposed between the controller and the first and second peripheral devices, respectively, the controller controlling the state of the first and second switches, the controller transmitting to and receiving data from the first and second peripheral devices via the digital bus and the first and second switches, the controller isolating a selected one of the first and second peripheral devices by controlling the state of an associated one of the first and second switches when data is not being transmitted to or received from the selected one of the first and second peripheral devices.

According to another aspect of the present invention, a method for operating a plurality of peripheral devices coupled to a digital bus comprises selecting one of the devices, wherein the selecting reserves the bus for use with the selected device; releasing the bus from the selected device while the selected device executes at least one command, thereby enabling another device to communicate via the bus; re-acquiring the bus, wherein the re-acquiring reserves the bus for use with the selected device; transferring data associated with the executed at least one command via the bus; and, de-selecting the device, thereby releasing the bus.

According to another aspect, an apparatus comprises a controller; an optical disk drive; a hard disk drive; and a switch coupled to the controller and switchably coupled to the optical disc drive and the hard disk drive; wherein the switch selectively isolates one of the optical disc drive and hard disk drive from the controller during execution of a command by the one of the optical disc drive and hard disk, to enable controller communications with the other of the optical disc drive and hard disk drive in parallel with the command execution.

### BRIEF DESCRIPTION OF THE FIGURES

Understanding of the present invention will be facilitated by consideration of the following detailed description of the preferred embodiments of the present invention taken in conjunction with the accompanying drawings, wherein like numerals refer to like parts and:

FIG. 1 illustrates a bus configuration;

FIG. 2 illustrates a process flow for operating the bus configuration of FIG. 1;

FIG. 3 illustrates an alternative bus configuration;

FIG. 4 illustrates a process flow for operating a bus configuration according to an aspect of the present invention;

FIG. 5 illustrates a bus configuration according to an aspect of the present invention;

FIGS. 6, 7 and 8 illustrate a process flow for operating the bus configuration of FIG. 5 according to an aspect of the present invention; and,

FIG. 9 illustrates an apparatus and its interconnections according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical hosts, buses and devices. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein is directed to all such variations and modifications to such elements and methods known to those skilled in the art.

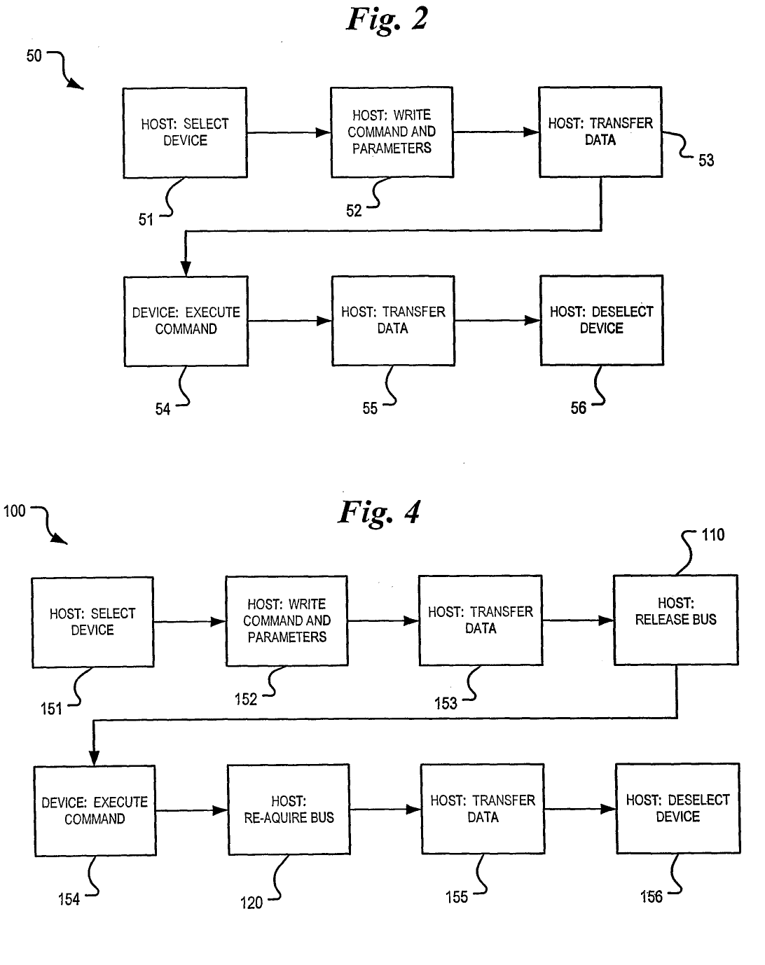

Referring again to FIG. 2, processes 51, 52, 53, 55 and 56 all require physical use of the ATA/ATAPI bus 30. Further, these processes may typically be executed very quickly (e.g., on the order of microseconds). In contrast, step 54 does not require physical use of the bus 30, and typically requires a relatively long time to execute (e.g., on the order of milliseconds to seconds). Thus, a common bus reserved for use by a selected device may remain idle for significant lengths of time, thereby degrading overall system performance. According to an aspect of the present invention, a common bus may be released from the selected device when idle during device command execution, thereby allowing another device to utilize the bus, thus improving overall system performance.

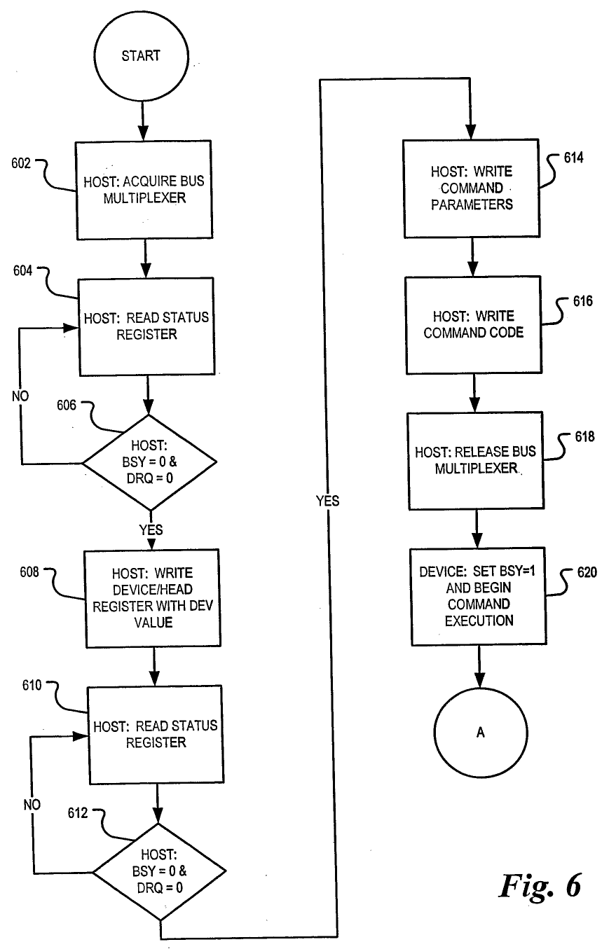

Referring now also to FIG. 4, there is shown a flow diagram of a methodology 100 according to an aspect of the present invention. Like process flow 50, a host employs a process 151 (similar to process 51) that selects a device. The host also employs a process 152 (similar to process 52) that writes a command and parameters to the selected device. Host process 153 (similar to process 53) transfers data to the selected device (e.g., write type commands). The selected device employs a process 154 (similar to process 54) that executes the command. The host employs a process 155 (similar to process 55) that transfers data from the selected device (read type commands). Finally, the host employs process 156 (akin to process 56) that de-selects the selected device. In contrast with process flow 50, the selected device is isolated from the ATA/ATAPI bus during command execution process 154, such that a command can be issued to another device. Such an approach is particularly well suited for use the PIO command protocol. Devices may be isolated from a common bus using physical isolation, for example. The desired isolation may be embodied in releasing the bus during command execution (process 110). The device is then re-selected for continued processing by the host (process 120), whereby the bus is available for further use with the originally selected device (e.g., process 155).

According to an aspect of the present invention, multiple instantiations of methodology 100 may be simultaneously executed. For example, in a first instantiation, processes 151, 152, 153 and 110 may be employed—such that a first selected device is triggered to employ process 154. While process 154 is being employed by the first selected device, a second instantiation of processes 151, 152, 153 and 110 may be employed—such that a second selected device is triggered to employ process 154. While process 154 is being employed by the second selected device, the first instantiation of processes 120, 155 and 156 maybe employed. Thereafter, the second instantiation of processes 120, 155 and 156 maybe employed. Thus, multiple devices may operate in parallel, with a common host and common bus. It is to be understood that parallel operation does not necessarily require that command execution occur simultaneously or concurrently over the entire duration, but merely parallel processing associated with the devices.

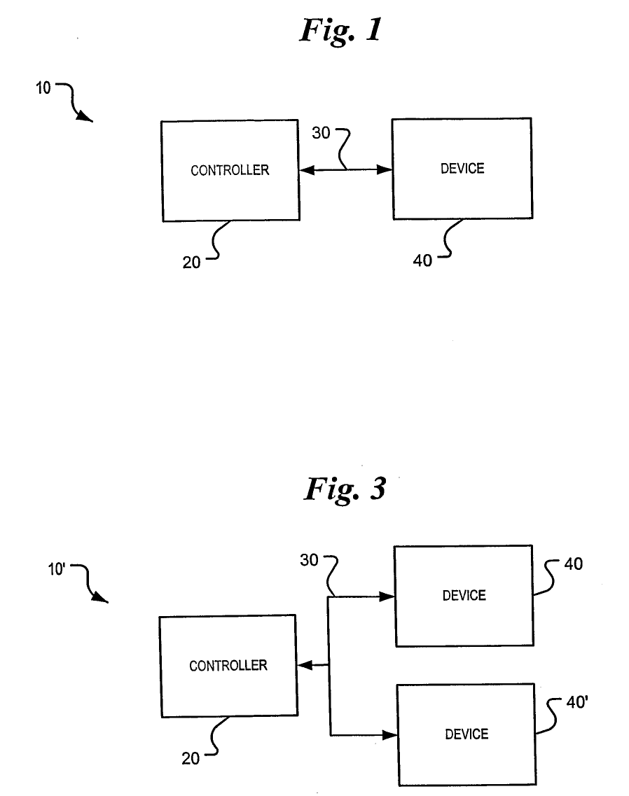

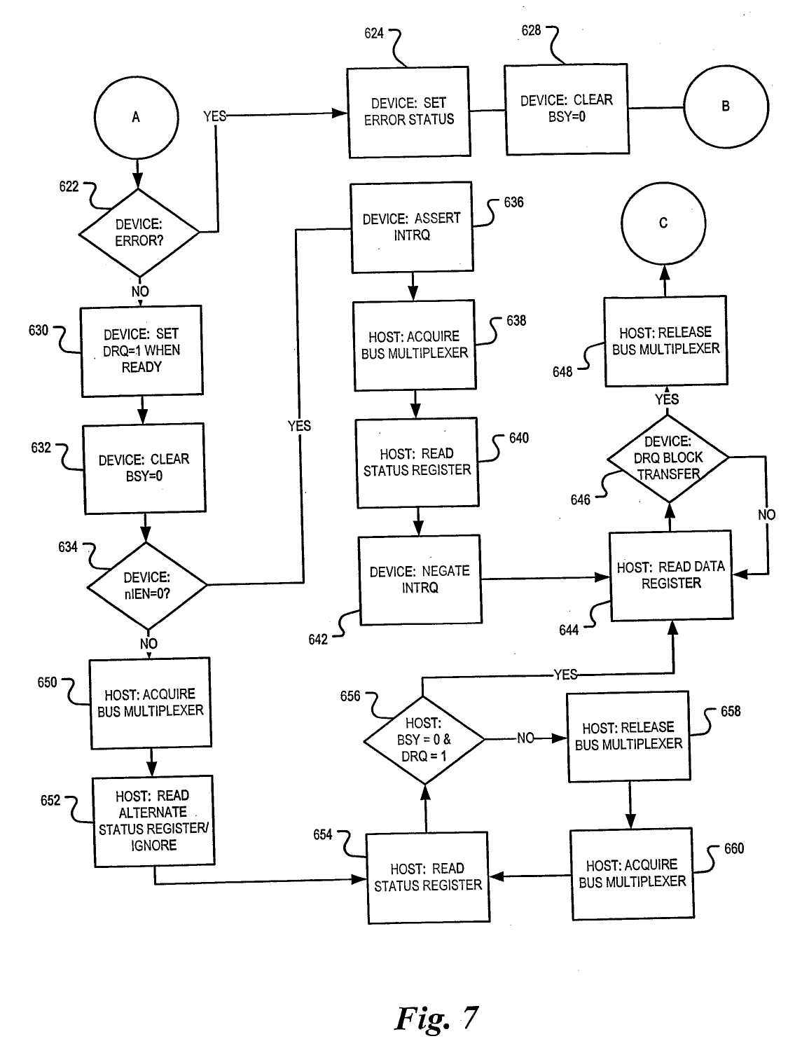

Referring now also to FIG. 5, there is shown a configuration 500 according to an aspect of the present invention. Configuration 500 includes a controller 520 communicatively coupled to devices 540, 540′ via buses 530, 530′, respectively, and multiplexer 550. In the case of an ATA/ATAPI compliant configuration, controller 520 (e.g., a host) may issue programmed input/output (PIO) commands to devices 540, 540′ sharing ATA/ATAPI bus 530, 530′ analogous to controller 20 (FIG. 1). Like devices 40, 40′, devices 540, 540′ may take the form of an optical disc device and a hard disk drive (HDD) device, respectively, for example. Unlike devices 40, 40′ though, devices 540, 540′ need not support a non-overlap capability. Further, unlike controller 20, controller 520 includes logic implementation 525 interfacing with multiplexer 550 via communications medium 560.

Logic implementation 525 may take the form of hardware, such as an application specific integrated circuit (ASIC) and/or software (e.g., one or more programs) stored in a computer readable medium (e.g., a memory) suitable for execution by a controller or device integrated processor. Logic implementation 525 may take the form of a combination of hardware and software, such as firmware, for example. Medium 560 may take the form of any standard interface medium suitable for passing data and commands between controller 520 and multiplexer 550. Medium 560 may take the form of a plurality of electrically conductive wires analogous to a bus, for example. While configuration 500 is suitable for employing methodology 100, as will be understood by those possessing an ordinary skill in the pertinent arts, other configurations may of course be used.

Multiplexer 550 may take the form of hardware, such as an application specific integrated circuit (ASIC) and/or software (e.g., one or more programs) stored in a computer readable medium (e.g., a memory) suitable for execution by a processor. Such a processor may be integrated into a circuitry package that also includes conventional pin connections, for example. Multiplexer 550 may be coupled to buses 530, 530′ in a conventional manner, analogous to controller 20 (FIG. 1), for example.

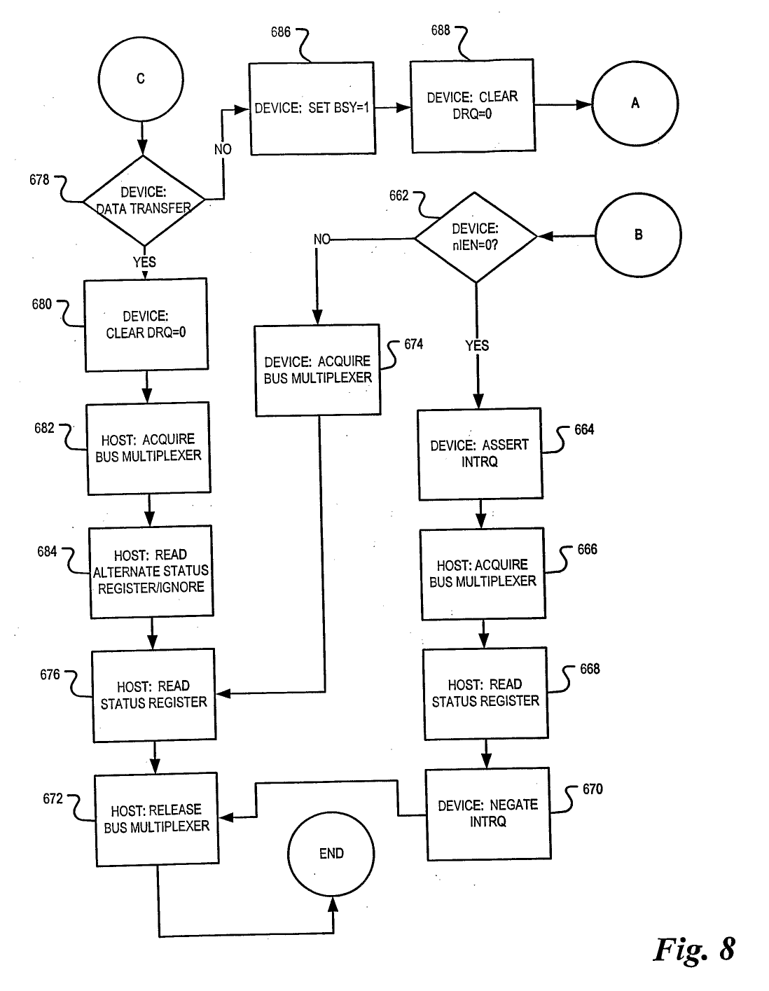

Referring now to FIGS. 6, 7 and 8, there is shown a flow diagram of methodology 600 (in the form of method portions 600a, 600b and 600c) according to an aspect of the present invention. While operational flow 600 is suitable for use with and will be discussed as it relates to an ATA/ATAPI specification compliant configuration 500, it may be suitable for use with a wide variety of configurations. Referring first to FIG. 6, there is shown methodology 600 portion 600a.

As shown is FIG. 6, operational flow 600a begins with a host 520 acquiring bus multiplexer 550 for a selected device, e.g., device 540, (process 602). Host 520 may acquire multiplexer 550, as well as write and read data, using logic implementation 525 via medium 560 and conventional signaling techniques. Thereafter, host 520 may read a status register associated with device 540 (process 604). Host 520 may then determine whether device 540 is busy by determining the value of the BSY and DRQ bits in the status register (process 606). For non-limiting purposes of explanation, the ATA specification calls for the status register to include bits indicative of: BSY (busy), DRDY (device ready), DF (Device Fault), DSC (seek complete), DRQ (Data Transfer Requested), CORR (data corrected), IDX (index mark) and ERR (error). If the BSY and DRQ values are determined to not both be zero, processing returns to process 604 (process 606). If the BSY and DRQ values are both determined to be zero, processing continues with host 520 writing a device/head register with a DEV bit value corresponding to device 540 (process 608). Thereafter, host 520 again reads the status register associated with device 540 (process 610). It should be understood that the host may wait at least 400 nanoseconds before reading a status register to ensure that the content thereof is valid. If the BSY and DRQ values are determined to not both be zero, processing returns to process 610 (process 612). If the BSY and DRQ values are determined to both be zero, processing continues with host 520 writing one or more command parameters for device 540, such as command parameters for features, sector count, sector number, cylinder high, cylinder low and device/head registers process 614). Thereafter, host 520 writes a command code to the command register (process 616), and releases bus multiplexer 550 (process 618). In response to these processes, device 540 then sets its status register to indicate it is busy (BSY=1), and begins command execution (process 620). As will be understood by those possessing an ordinary skill in the pertinent arts, processes 604-616 and 620 are individually conventional in form and comply with the ATA specification in the case of an ATA specification compliant configuration 500.

Referring now also to FIG. 7, there is shown operational flow 600b. After command execution (process 620), device 540 may determine if an error has occurred and is to be reported (process 622). If an error is to be reported (process 622), an error status indicator may be set, such as the aforementioned ERR bit in the status register (process 624). Optionally, device 540 may assert an interrupt at this point. Either way, the device may then clear the busy indicator by setting BSY=0 (process 628).

When no device error is to be reported (process 622), device 540, when ready to transfer a data block, sets DRQ=1 in the status register (process 630). Thereafter, the device clears the busy indicator by setting BSY=0 in the status register (process 632). Device 540 then checks the nIEN bit in the control register to see if interrupts are enabled in the device 540 (process 634). If the nIEN bit is determined to be set to zero (process 632), device 540 asserts an interrupt request (e.g., sets field INTRQ) (process 636). Thereafter, host 520 again acquires the bus multiplexer 550 for device 540 (process 638), and reads the status register (process 640). Device 540 then negates the interrupt request (e.g., resets INTRQ) (process 642), and host 520 reads the data register (process 644) corresponding to device 540.

Device 540 then determines whether a block transfer corresponding to the data request (DRQ) has occurred (process 646). If such a transfer has not occurred, processing returns to process 644 until the block transfer is determined to have occurred. Once the transfer has been determined to have occurred (process 646), host 520 releases bus multiplexer 550 for use with other devices (process 648).

If the nIEN bit is determined to be set to 1 (process 632), host 520 acquires bus multiplexer 550 (process 650). Host 520 then reads the alternate status register, but disregards the results (process 652). As will be understood by those possessing an ordinary skill in the pertinent arts, this prevents a polling host from reading the status register before it is valid. Thereafter, host 520 reads the status register (process 654), and determines whether device 540 is busy and whether data is available for transfer by determining the value of the BSY and DRQ bits (process 656).

If device 540 is not busy (BSY=0) and data is available for transfer (DRQ=1), processing continues with process 644 described above. If device 540 is busy (BSY=1), or if data is not available for transfer (DRQ=0), then host 520 releases bus multiplexer 550 (process 658). After some period of time, host 520 reacquires bus multiplexer 550 for device 540 (process 660) and processing continues with process 654.

Referring now to FIG. 8, there is shown operational flow portion 600c. After an error status has been set (process 624) and the busy flag cleared (process 628), device 540 checks the nIEN bit in the control register to determine whether interrupts are enabled in the device 540 (process 662). If the nIEN bit is determined to be set to zero (process 662), device 540 asserts an interrupt request (e.g., sets INTRQ) (process 664). Thereafter, host 520 again acquires the bus multiplexer 550 for device 540 (process 666). After bus multiplexer acquisition, host 520 reads the status register (process 668). Thereafter, device 540 negates the interrupt request (e.g., resets INTRQ) (process 670), and host 540 reads the data register (process 672) corresponding to device 540. If the nIEN bit is determined to be set to 1 (process 662), host 520 acquires bus multiplexer 550 (process 674). Host 520 then reads the status register (process 676), and processing continues with process 672.

Referring still to FIG. 8, after host 520 has released bus multiplexer 550 (process 648), device 540 determines whether all data for an issued command has been transferred (process 678). If all data has been transferred (process 678), device 540 clears the data request flag (resets DRQ=0) (process 680). Thereafter, host 520 acquires bus multiplexer 550 for device 540 (process 682) and reads the alternate status register, disregarding the results (process 684). As will be understood by those possessing an ordinary skill in the pertinent arts, this prevents a polling host from reading the status register before it is valid. Processing then continues with process 676.

If all data has not been transferred (process 678), device 540 sets the device busy indicator (BSY=1) (process 686) and resets the data request indicator (DRQ=0). Thereafter, processing continues with step 622 (off page indicator A, FIG. 7).

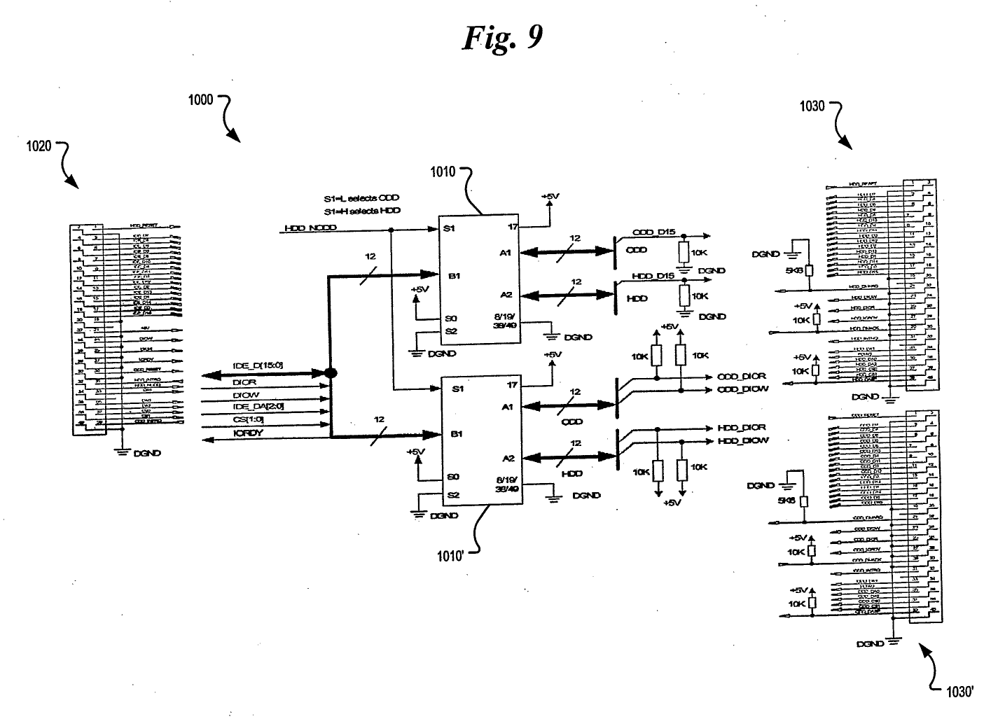

Referring now also to FIG. 9, there is shown a configuration 1000 according to an aspect of the present invention. Configuration 1000 uses multiple bus switches to isolate the data, I/O read (DIOR), I/O write (DIOW), I/O ready (IORDY), device address (IDE_DA[2:0]), and chip select (CS[1:0]) signals of two ATA/ATAPI devices from a host. The bus switches are controlled by host software (e.g., interface logic 525, FIG. 5) using a HDD_NODD signal. As will be recognized by those possessing an ordinary skill in the pertinent arts, the reset and interrupt signals of the ATA/ATAPI devices are not multiplexed.

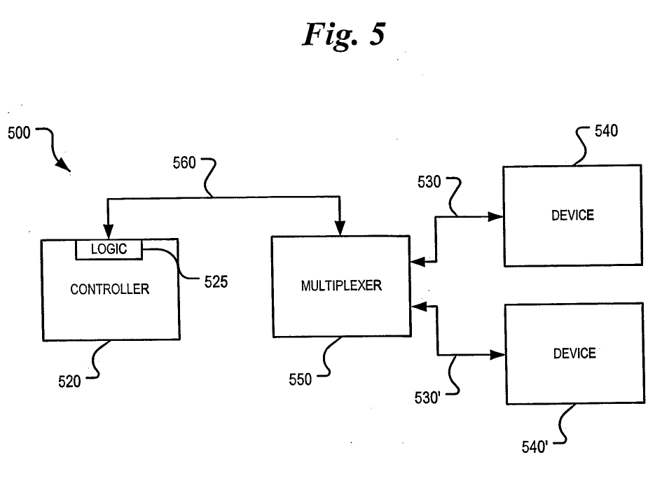

More particularly, configuration 1000 includes a plurality of switches 1010, 1010′ communicatively interposed between ATA specification compliant interface pin configurations 1020 and 1030, 1030′. Pin configuration 1020 is largely analogous to a conventional ATA controller pin configuration, with the exception of pin 32 used to provide the HDD_NODD signal, duplicative interrupt request (INTRQ) signals being provided on pins 31 and 39, and duplicative reset (RESET) signals being provided on pins 1 and 29. Pin configuration 1020 may be coupled to switches 1010, 1010′ in an analogous manner as a conventional ATA host is coupled to conventional ATA devices (see, e.g., FIGS. 1 and 3)—with the exception of the duplicative interrupt and reset signal carrying pins.

Switches 1010, 1010′ may each take the form of 24-bit bus exchange switches commercially available from Integrated Device Technology, Inc., under the model designation IDTFST163212. The HDD_NODD signal may be provided on the S1 control pin of each such integrated device. The S0 control pin of each switch is provided with a +5V signal. The S2 control pin of each switch is grounded. Additionally, pins 8 (GNTD), 19 (GND), 38 (GND) and 49 (GND) of each such device are grounded. The bus pins from pin configuration 1020 are communicatively coupled to the B bus pins of each switch.

Pin configurations 1030, 1030′ maybe largely analogous to conventional ATA device pin configurations. The ATA signals D15-D0, DIOR, DIOW, DA0-DA2, CS0-CS1, and IORDY may be arbitrarily spread across the two twelve-bit wide switches 1010, 1010′. In the illustrated case, device pin configuration 1030 is associated with a hard disk drive (HDD) and device pin configuration 1030′ is associated with an optical disc drive (ODD). The hard disk reset signal (HDD_RESET) provided on pin 1 of configuration 1020 is coupled to pin 1 of configuration 1030. Analogously, the optical disc drive reset signal (ODD_RESET) provided on pin 29 of configuration 1020 is provided on pin 1 of configuration 1030′. Further, the hard disk drive interrupt request signal (HDD_INTRQ) provided on pin 31 of configuration 1030 is provided on pin 31 of configuration 1020. The optical disc drive interrupt request signal (ODD_INTRQ) provided on pin 31 of configuration 1030′ is provided on pin 39 of configuration 1020. The bus pins of configuration 1030 are coupled to the A2 bus pins of switches 1010, 1010′. The bus pins of configuration 1030′ are coupled to the A1 bus pins of switches 1010, 1010′. The hard disk drive input/output (I/O) read (HDD_DIOR) signal on pin 25 and hard disk drive input/output (I/O) write (HDD_DIOW) signal on pin 23 of configuration 1030 are coupled to the A2 bus connection of switches 1010′, 1010′. While the optical disc drive input/output (I/O) read (ODD_DIOR) signal on pin 25 and optical disc drive input/output (I/O) write (ODD_DIOW) signal on pin 23 of configuration 1030′ are coupled to the A1 bus connection of switches 1010, 1010′.

In such a configuration, a low HDD_NODD state selects the device pin configuration 1030′ and a high HDD_NODD state selects the device pin configuration 1030.

According to an aspect of the present invention, an application specific integrated circuit (ASIC) for coupling the additional signals (e.g., duplicative reset and interrupt request signals and the HDD_NODD signal) onto an ATA standard pin configuration may be provided. Such an ASIC may optionally incorporate the switches, as well as other conventional components used in ATA compliant coupling, such as resistors.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. An apparatus comprising:
a first peripheral device coupled to a digital bus;
a second peripheral device coupled to the digital bus;
a controller coupled to the first and second peripheral devices via the digital bus, the digital bus including first and second switches disposed between the controller and the first and second peripheral devices, respectively, the controller controlling the state of the first and second switches, the controller transmitting to and receiving data from the first and second peripheral devices via the digital bus and the first and second switches, the controller isolating a selected one of the first and second peripheral devices by controlling the state of an associated one of the first and second switches when data is not being transmitted to or received from the selected one of the first and second peripheral devices.

2. The apparatus of claim 1, wherein at least one of said devices is an ATA device.

3. The apparatus of claim 1, wherein said controller is an ATA controller.

4. The apparatus of claim 3, wherein at least one of said devices is not overlap enabled.

5. The apparatus of claim 1, further comprising a plurality of interrupt signaling communications paths between said controller and said devices bypassing said switches.

6. The apparatus of claim 1, further comprising a plurality of reset signaling communications paths between said controller and said devices bypassing said switches.

7. The apparatus of claim 1, wherein said switches are integrated in an integrated circuit further comprising a plurality of bus connections.

8. A method for operating a plurality of peripheral devices coupled to a digital bus comprising:
selecting one of said devices, wherein said selecting reserves said bus for use with said selected device;
releasing said bus from the selected device while said selected device executes at least one command, thereby enabling another device to communicate via said bus;
re-acquiring said bus, wherein said re-acquiring reserves said bus for use with said selected device;
transferring data associated with said executed at least one command via said bus; and,
de-selecting said device, thereby releasing said bus.

9. The method of claim 8, further comprising:
selecting another of said devices while said first selected device executes said at least one command, wherein said selecting another reserves said bus for use with said selected another device; and,
releasing said bus while said selected other device executes at least one command.

10. The method of claim 9, wherein said re-acquiring and transferring data via said bus occurs while said selected another device executes said at least one command.

11. The method of claim 10, further comprising:
re-acquiring and transferring data from said other selected device via said bus; and,
de-selecting said other selected device, thereby releasing said bus.

12. The method of claim 8, further comprising writing at least one command to said selected device, writing at least one parameter to said selected device and transferring data to said selected device.

13. The method of claim 8, further comprising signaling at least one multiplexer.

14. The method of claim 13, wherein said multiplexer comprises a plurality of switches communicatively interposed between a controller and said device.

15. An apparatus comprising:
a controller;
an optical disk drive;
a hard disk drive;
a switch coupled to said controller and switchably coupled to said optical disc drive and said hard disk drive;
wherein the switch selectively isolates one of the optical disc drive and hard disk drive from the controller during execution of a command by said one of the optical disc drive and hard disk, to enable controller communications with the other of the optical disc drive and hard disk drive in parallel with said command execution.

16. The apparatus of claim 15, wherein said controller is ATA compliant.

17. The apparatus of claim 16, wherein said optical disc drive is not overlap enabled.

18. The apparatus of claim 17, wherein said optical disc drive is a DVD drive.

19. The apparatus of claim 15, further comprising at least one multimedia data content decoder.

20. The apparatus of claim 15, wherein said apparatus is a set-top box.
